(19) United States
(12) Patent Application Publication
(10) Pub. No.: US 2009/0295638 A1
(43) Pub. Date: Dec. 3, 2009

(54) USE OF A MEASUREMENT SIGNAL EVALUATION MEANS OF A POSITION MEASURING DEVICE TO DETERMINE THE TIME DIFFERENCE BETWEEN A FIRST EVENT AND A SECOND EVENT

(75) Inventor: Roland Finkler, Erlangen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/471,858

(22) Filed: May 26, 2009

(30) Foreign Application Priority Data
May 27, 2008 (EP) EP 08 00 9649

(51) Int. Cl. G01S 1/24

(52) U.S. Cl. 342/387

(57) ABSTRACT

A position measurement system is provided to determine a time difference between a first event and a second event. Position values are hereby determined from an individual periodic signal or from a plurality of periodic signals, wherein a first position value is determined using a measurement signal evaluation means when a first event occurs, and a second position value is determined using the measurement signal evaluation means when the second event occurs. The time difference is determined from the first and second position values. As a result, the time difference can be measured between two events with a high temporal resolution, with a reduction of electromagnetic interference caused by the time measurement.

### CROSS-REFERENCES TO RELATED APPLICATIONS

This application claims the priority of European Patent Application, Serial No. EP 08009649, filed May 27, 2008, pursuant to 35 U.S.C. 119(a)-(d), the content of which is incorporated herein by reference in its entirety as if fully set forth herein.

### BACKGROUND OF THE INVENTION

The present invention relates to a measurement signal evaluation of a position measuring device.

The following discussion of related art is provided to assist the reader in understanding the advantages of the invention, and is not to be construed as an admission that this related art is prior art to this invention.

In technical systems, in particular in automation technology, it is often necessary to determine the time difference between the occurrence of two events in a very accurate manner for a wide variety of tasks. A periodic square-wave pulse signal which is generated by a clock generator is usually used for this purpose. In commercially available systems, the time difference between the two events is determined from the number of square-wave pulses between the two events.

The resolution of the time difference between two events is thus limited by the frequency at which the square-wave pulses are generated by the clock generator. The higher the intended temporal resolution of the determined time difference, the higher the selected frequency of the square-wave pulse signal must be. If a very high resolution is intended to be achieved, the frequency of the square-wave pulse signal must accordingly be selected to be high, that is to say the square-wave pulses follow one another at very short intervals of time. However, square-wave pulse signals at a high frequency produce electromagnetic interference which may result in malfunctions, in particular in electrical components arranged in the vicinity.

Conventional clock frequencies which are used, for example, are in a range of 100 MHz or more. In this context, it is conceivable to evaluate a plurality of clock signals, which are delayed with respect to one another, using a plurality of logic gates in order to increase the temporal resolution. However, a very large number of delay elements are required in this case.

Furthermore, the time difference between two events can be measured by sampling a linearly rising voltage, for example by sampling the voltage across a capacitor which is charged using a current source. However, such a time measurement is relatively inaccurate.

In commercially available position measuring devices for measuring a position, for example, of a movable machine element, for example a motor shaft, two signal transmitters generally scan a movable material measure and, in a manner corresponding to the graduation arranged on the material measure, generate periodic signals which are used to determine the current position of the machine element with the aid of a measurement signal evaluation means. An example of such a position measuring device is described in German Pat. No. DE 10 2004 038 621 B3, whereby a position is determined from two sinusoidal signals, which have a phase offset with respect to one another, using a measurement signal evaluation means. Two signal transmitters scan the material measure graduation and output the two sinusoidal measurement signals which have a phase offset with respect to one another. The two measurement signals are then sampled in a fixed time frame using two analog/digital converters. A downstream measurement signal evaluation means determines the position signal from the two measurement signals which have been digitized in this manner. The measurement signal evaluation means subjects the measurement signals to analog/digital conversion on the input side and outputs the position signal determined by it on the output side.

In general, commercially available position measuring devices generally have a measurement signal evaluation means which determines a position signal, i.e. a position, from two or more measurement signals.

German patent document DE 27 29 697 A1 discloses a measurement signal evaluation means of a position measuring device to determine a position signal from two measurement signals. In this case, in order to increase the accuracy, such commercially available measuring devices often also include, for example, special methods for compensating for and/or correcting offset, amplitude, phase and harmonic errors in the measurement signals in order to increase the accuracy of the position determined.

Common to conventional measurement signal evaluation means of position measuring devices is the determination of a corresponding position, i.e. a corresponding position signal, from relatively low-frequency measurement signals with a very high level of accuracy.

It would be desirable and advantageous to address prior art shortcomings and to measure a time difference between two events with a high temporal resolution, electromagnetic interference caused by the time measurement being reduced.

### SUMMARY OF THE INVENTION

According to one aspect of the present invention, a method for determining a time difference between a first event and a second event includes the steps of determining a first position value from a first periodic signal that is triggered when the first event occurs, determining a second position value from a second periodic signal that is triggered when the second event occurs, and determining the time difference from a difference between the first and second position values.

According to another aspect of the present invention, a position measuring system includes a measurement signal evaluation means for determining a time difference between a first event and a second event, the measurement signal evaluation means configured to determine a first position value from a first periodic signal that is triggered when the first event occurs, determine a second position value from a second periodic signal that is triggered when the second event occurs, and determine the time difference from a difference between the first and second position values.

According to yet another aspect of the present invention, q position measuring system includes a first signal generator signal producing a first periodic signal, a first A/D converter receiving the first periodic signal, a second signal generator signal producing a second periodic signal, a second A/D converter receiving the second periodic signal, an OR gate receiving a first trigger signal produced by an occurrence of a first event, and a second trigger signal and second event respectively, and transmitting the first and second trigger signals to corresponding trigger inputs of the first and second A/D converters and producing first and second triggered output signals that correspond to the periodic signals at a time of the first and second event, and an evaluation unit receiving at a first input the first triggered output signals corresponding to values of the first periodic signal for the first event and the second event, and receiving at a second input the second triggered output signals corresponding to values of the second periodic signal for the first event and the second event, the evaluation unit having an output that generates position values to be used for determining the time difference from a position difference between the first and second position values.

The present invention resolves prior art problems by determining the time difference through determination of the positional difference between the first position value and the second position value and weighting the positional difference with a proportionality factor. This ensures simple determination of the time difference. It also proves to be advantageous if the periodic signal is generated using a signal generator assigned to the periodic signal or the periodic signals are generated using signal generators assigned to the periodic signals. This makes it possible to generate the periodic signal or the periodic signals in a particularly simple manner.

It also proves to be advantageous if the periodic signal or the periodic signals is/are sampled solely when the first and second events occur in order to generate input values for the measurement signal evaluation means. This makes it possible to use the measurement signal evaluation means in a simple manner.

It also proves to be advantageous if the time difference determined in this manner is used to determine the position of a movable magnet in a magnetostrictive position measuring device. A high temporal resolution is required, in particular, in magnetostrictive position measuring devices.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an exemplary embodiment of the invention,

FIG. 2 shows two periodic signals,

FIG. 3 shows a diagrammatic illustration of a commercially available magnetostrictive position measuring system,

FIG. 4 shows the determination of a position from the time difference determined, and

FIG. 5 shows another exemplary embodiment of the invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

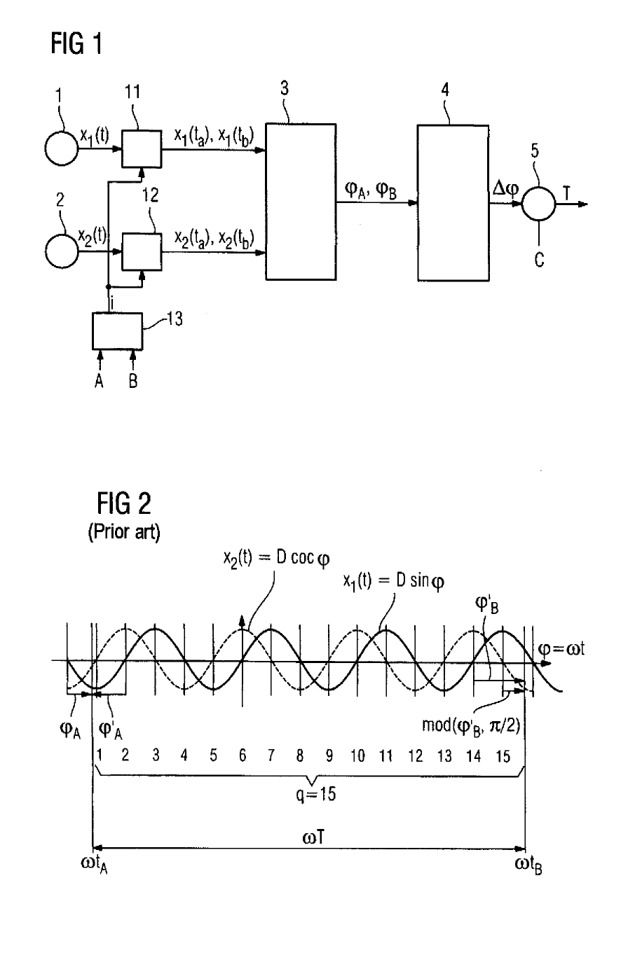

According to the present invention, a measurement signal evaluation means is used to determine the time difference between a first event and a second event. FIG. 1 shows a diagrammatic illustration of an exemplary embodiment of the present invention. A first signal generator 1 generates a first periodic signal x₁(t) and a second signal generator 2 generates a second periodic signal x₂(t). Within the scope of the exemplary embodiment, the two signals x₁(t) and x₂(t) are sinusoidal and are temporally offset with respect to one another. However, the two signals may also have other signal waveforms which are not sinusoidal. In addition, the two signals need not necessarily have the same signal waveform. However, they should preferably not have a square-wave signal waveform.

The two signals x₁(t) and x₂(t) are supplied, as an input variable, to the respectively associated analog/digital converters 11 and 12. When a first event A occurs and when a second event B occurs, a gate pulse i is respectively generated at the output of a logic OR gate 13, which pulse causes the two analog/digital converters 11 and 12 to respectively sample the analog signals x₁(t) and x₂(t) once. The occurrence of the first event A and of the second event B is supplied in this case to the OR gate 13 in the form of a respective trigger pulse as an input variable. The two analog/digital converters 11 and 12 thus generate the signal values x₁(tₐ) and x₂(tₐ) sampled at the time tₐ at which the first event A occurs and the signal values x₁(t_{b}) and x₂(t_{b}) sampled at the time t_{b} at which the second event B occurs. The signal values x₁(tₐ) and x₂(tₐ) and the signal values x₁(t_{b}) and x₂(t_{b}) are then supplied, as input values, to a measurement signal evaluation means 3 which is known from the prior art and carries out the measurement signal evaluation already described.

On the output side, the measurement signal evaluation unit 3 determines a position value f_{A} from the two signal values x₁(tₐ) and x₂(tₐ) and a position value f_{B} from the two signal values x₁(t_{b}) and x₂(t_{b}). In this case, the measurement signal evaluation which is carried out in the measurement signal evaluation unit 3 corresponds, for example, to the measurement signal evaluation disclosed in German patent document DE 10 2004 038 621 B3, with the difference that in accordance with the invention, the two signal transmitters, as described in German patent document DE 10 2004 038 621 B3 and the material measure are replaced with the two first and second signal generators 1 and 2 indicated in FIG. 1 and that the two analog/digital converters are driven in such a manner that they no longer sample the signals in a fixed time frame (for example every 0.125 ms) but rather only once when the first event A occurs and once when the second event B occurs. In this case, the two signal generators generate periodic signals with a period duration which is always constant and consequently at a frequency which is always constant. In this case, the position values f_{A} and f_{B} in FIG. 1 of the present application correspond to individual values of the position signal as referred to in German patent document DE 10 2004 038 621 B3. Alternatively, of course, the measurement signal evaluation means could also be in the form of the measurement signal evaluation means, as described for example in German patent document DE 27 29 697 A1. As already stated, it is possible, in principle, to use any measurement signal evaluation means (which is known from the prior art) of position measuring devices to implement the invention, the signal generators having to generate signals which are adapted to the respectively used measurement signal evaluation means and can be processed by the respectively used measurement signal evaluation means.

As illustrated in FIG. 11 the position values f_{A} and f_{B} determined in this manner are supplied, in a next step, to a positional difference determination unit 4 as an input variable. The positional difference determination unit 4 then calculates the positional difference Δφ between the first and second position values by subtracting the first position value f_{A} from the second position value f_{B} according to the relationship

Δφ=φ_{B}−f_{A}

within the scope of the exemplary embodiment.

On the output side, the positional difference determination unit 4 outputs the positional difference Δφ determined in this manner to a multiplier 5 within the scope of the exemplary embodiment, said multiplier weighting the positional difference Δφ by multiplying it by a proportionality factor C within the scope of the exemplary embodiment. The proportionality factor C depends on the frequency f of the periodic signals x₁(t) and x₂(t) and, provided that the two signals x₁(t) and x₂(t) are at the same frequency f and are sinusoidal and are temporally offset with respect to one another, results, for example, as:

$$C = \frac{1}{ω} where$$

$$ω = 2 p f .$$

With the aid of the weighting which is carried out in this manner in the form of a multiplication by the proportionality factor C, the positional difference Δφ determined is converted into a corresponding time difference T and is output at the output of the multiplier 5. The time difference T determined in this manner can then be processed further in any desired manner according to the respective technical requirements.

For the sake of completeness, FIG. 2 again illustrates, by way of example, a simple generally known implementation of the functionality of the measurement signal evaluation unit 3, the two periodic signals x₁(t) and x₂(t) being plotted against the position, which is given by the angle

φ=ωt

within the scope of the exemplary embodiment, rather than against time t. In this case, the two periodic signals x₁(t) and x₂(t) are given by

x₁(t)=D sin(ω·t), x₂(t)=D cos(ω·t)

D: amplitude.

When the event A occurs at the time t_{A}, the two signal values

x₁(t_{A})=D sin(ω·t_{A}) and

x₂(t_{A})=D cos(ω·t_{A})

are detected and, when the event B occurs at the time t_{B}, the two signal values

x₁(t_{B})=D sin(ω·t_{B}) and

x₂(t_{B})=D cos(ω·t_{B})

are detected.

The following is first of all calculated from the signal values detected on the basis of the event A:

f′_{A}=a tan 2(x₁(t_{A}), x₂(t_{A}))=arg(x₂(t_{A})+jx₁(t_{A})),

where a tan 2(b, a) and arg(a+jb) denote the argument of the complex number a+j b, with −p=arg(a+jb)=p (that is to say a+jb=|a+jb|e^{j arg(a+jb)}).

The following is then calculated:

f_{A}=mod(f′_{A},p/2), where mod( ) is the modulo function.

In a corresponding manner, the following is calculated from the signal values detected on the basis of the event B:

f′_{B}=a tan 2(x₁(t_{B}), x₂(t_{B}))=arg(x₂(t_{B})+jx₁(t_{B})).

The number q of zero crossings of the signals x₁(t) and x₂(t) between the events A and B is also determined. q is then increased by 1 if the first zero crossing counted

was a positive zero crossing of x₁(t) in the case −p=f′_{A}<−p/2,
was a negative zero crossing of x₂(t) in the case −p/2=f′_{A}<0,
was a negative zero crossing of x₁(t) in the case 0=f′_{A}<p/2, or
was a positive zero crossing of x₂(t) in the case p/2=f′_{A}<P;
in contrast, q is decreased by 1 if the first zero crossing counted
was a negative zero crossing of x₁(t) in the case −p=f′_{A}<−p/2,
was a positive zero crossing of x₂(t) in the case −p/2=f′_{A}<0,
was a positive zero crossing of x₁(t) in the case 0=f′_{A}<p/2, or
was a negative zero crossing of x₂(t) in the case p/2=f′_{A}<p.

Subsequently, q is increased by 1 again if the last zero crossing counted

was a negative zero crossing of x₂(t) for −p=f′_{B}<−p/2,
was a negative zero crossing of x₁(t) for −p/2=f′_{B}<0,
was a positive zero crossing of x₂(t) for 0=f′_{B}<p/2, or
was a positive zero crossing of x₁(t) for p/2=f′_{B}<P;
in contrast, q is decreased by 1 if the last zero crossing counted was a positive zero crossing of x₂(t) for −p=f′_{B}<−p/2,
was a positive zero crossing of x₁(t) for −p/2=f′_{B}<0,
was a negative zero crossing of x₂(t) for 0=f′_{B}<p/2, or
was a negative zero crossing of x₁(t) for p/2=f′_{B}<P

As a result, q−1 indicates the number of quadrants of the signals x₁(t), x₂(t) which have been completely passed through between the events A and B. The possible corrections by +1 or −1 according to the first and last zero crossings counted are necessary in this case because measurement inaccuracies may result in inconsistencies both between the first zero crossing counted and the quadrant determined for f_{A} and between the last zero crossing counted and the quadrant determined for f′_{B}.

Instead of the above-described determination of q, DE 27 29 697 A1 uses a direction discriminator and an electronic up/down counter since there the process does not start from a sin/cos transmitter which rotates at a constant angular velocity but rather must also take changes in the direction of rotation into account.

The following:

f_{B}=q·p/2+mod(f′_{B},p/2)

is then calculated.

The positional difference then results as

Δφ=φB−f_{A}

and is output at the output of the positional difference determination unit 4.

The time difference T then results as

$$T = C \cdot Δ ϕ = \frac{1}{ω} ( {f}_{B} - {f}_{A} ) ,$$

where the above relationship is implemented in the multiplier 5.

The invention can be used in a particularly advantageous manner in position measuring systems for measuring a position, for example in magnetostrictive position measuring systems in which it is necessary to accurately determine the time difference between two events, which occur after one another in a short period of time, in order to determine a position.

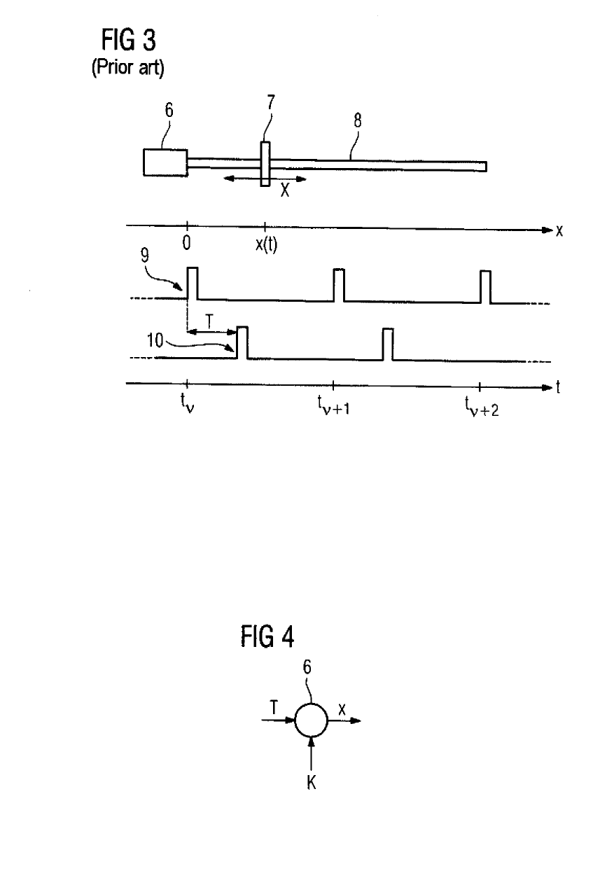

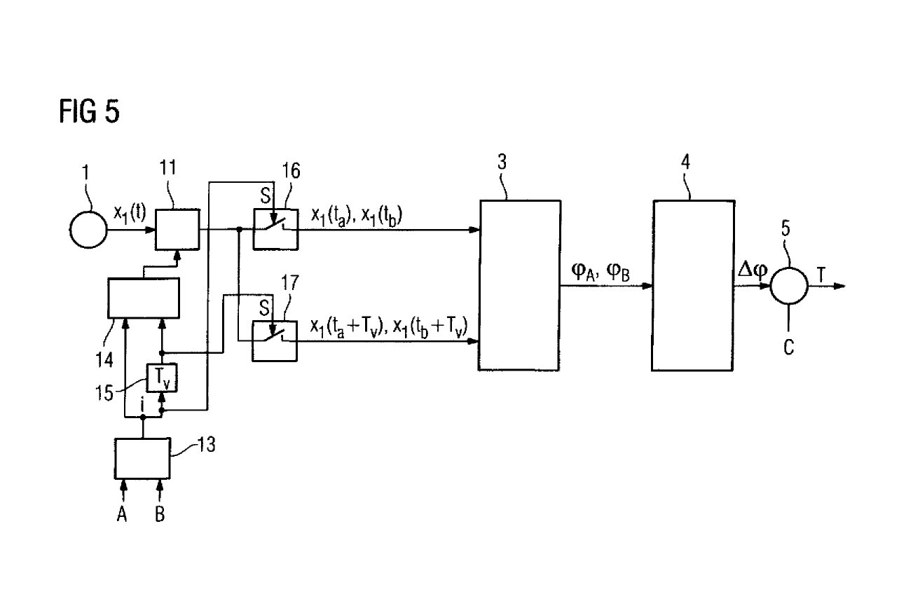

FIG. 3 illustrates the principle of commercially available magnetostrictive position measuring systems. In this case, a magnet which is preferably in the form of an annular permanent magnet 7 is moved along a measuring rod 8, which is guided through the permanent magnet 71, along the direction of movement X. In this case, sensor electronics 6 determine the position x(t), that is to say the position of the permanent magnet 7. For this purpose, the sensor electronics 6 generate, in a fixed timing pattern (for example one millisecond), starting pulses 9 which pass through the measuring rod 8 as current pulses. The magnetic field carried along by the current pulse produces mechanical torsion in the measuring rod 8 at the position of the permanent magnet, which torsion produces a structure-borne sound wave, which runs back to the sensor electronics 6, inside the measuring rod 8. The arrival of this structure-borne sound wave is recorded in the sensor electronics 6 and is converted into a stopping pulse 10. In this case, the time difference T between the starting pulse (corresponds to event A) and the associated stopping pulse (corresponds to event B) is proportional to the position x(t) of the permanent magnet 7.

In order to determine the position x of the permanent magnet 7 at the time tᵥ (occurrence of event A), the time difference T is multiplied by a constant K using a multiplier 6, the constant K resulting from the speed of the structure-borne sound wave in the measuring rod 8 whilst disregarding the propagation time of the electrical starting pulses 9.

The position x of the permanent magnet 7 at the time tᵥ thus results as

x=K·T.

The time difference T to be determined between the starting pulse, which represents the first event A according to FIG. 1 and the associated description, and the associated stopping pulse, which represents the second event B according to FIG. 1, is very small in this case, in particular in the case of magnetostrictive position measuring systems. Therefore, the use of the invention is particularly suitable for magnetostrictive position measuring systems since, as already stated, the time difference T to be measured between the two events is very small and a high square-wave pulse signal frequency (100 MHz or higher) is consequently needed for the time measurement in order to measure the time difference in commercially available magnetostrictive position measuring systems if a high resolution of the time measurement is intended to be achieved. However, this high-frequency clock signal which is required in commercially available magnetostrictive position measuring systems is a source of electromagnetic interference which, in particular, interferes, for example, with the sensitive sensor electronics 6 (according to FIG. 3) of the magnetostrictive position measuring system. With an accordingly identical temporal resolution, only the relatively low-frequency (for example 0.5 MHz or lower) periodic signals x₁(t) and x₂(t) are needed with the aid of the invention, which signals produce considerably less electromagnetic interference on account of their considerably lower frequency and their sinusoidal shape instead of a square-wave shape.

The interference caused by the necessary time measurement can thus be reduced by the invention.

However, it goes without saying that the invention can also be used in other types of position measuring systems which are based on the measurement of a propagation time, that is to say in other types of position measuring devices which are based on the measurement of a propagation time.

Magnetostrictive position measuring systems are disclosed, for example, in U.S. Pat. No. 5,334,933, U.S. Pat. No. 3,898,555 and European patent document EP 0 442 985 B1. Furthermore, magnetostrictive position measuring systems are disclosed in the book entitled “Lineare Weg-und Abstandssensoren” [Linear Displacement and Distance Sensors], 2004, ISBN 3-937889-07-8, pages 53 to 66. Magnetostrictive position measuring systems are also disclosed, for example, in a leaflet entitled “Magnetostriktion, Physikalische Grundlagen” [Magnetostriction, Physical Principles] from MTS Sensors which is disclosed on the web page www.mtssensor.de/fileadmin/medien/downloads/mts_messprinzip.pdf.

FIG. 5 illustrates another exemplary embodiment of the present invention. The basic structure and method of operation of the embodiment illustrated in FIG. 5 essentially correspond to those of the embodiment described above in FIG. 1. Therefore, in FIG. 5, the same elements have been provided with the same reference symbols as in FIG. 1. The fundamental difference is that, in the embodiment according to FIG. 5, only a first periodic signal x₁(t) and consequently also only a first signal generator 1 are needed to determine the time difference T. In comparison with the embodiment according to FIG. 1, the circuit illustrated in FIG. 5 is extended with a further logic OR gate 14, which ORs its input signals, and a time delay element 15, which delays its input signal by the period of time T_{V}, and two switches 16 and 17.

The signal x₁(t) is supplied to the analog/digital converter 11 as an input variable. When a first event A occurs and when a second event B occurs, a gate pulse i is respectively generated at the output of the logic OR gate 13, which pulse is forwarded via the OR gate 14 and causes the analog/digital converter 11 to respectively sample the analog signal x₁(t) once. The occurrence of the first event A and of the second event B is supplied in this case to the OR gate 13 in the form of a respective trigger pulse as an input variable.

The analog/digital converter 11 thus generates the signal value x₁(tₐ) sampled at the time tₐ at which the first event A occurs and the signal value x₁(t_{b}) sampled at the time t_{b} at which the second event B occurs. However, after each occurrence of an event, the time delay element 15 causes the analog/digital converter 11 to carry out a further sampling operation, which is temporally offset by the period of time T_{V}, and thus to generate the signal values x₁(tₐ+T_{V}) and x₁(t_{b}+T_{V}) on the output side. The switches 16 and 17 are used to output the signal values x₁(tₐ), x₁(tₐ+T_{V}), x₁(t_{b}) and x₁(t_{b}+T_{V}) to the measurement signal evaluation means 3 as input values, the switches 16 and 17 switching their input signal through to their output when a logic “1” occurs at their control input S.

In this case, the signal value x₁(tₐ+T_{V}) corresponds to the signal value x₂(tₐ) according to FIG. 1 and the signal value x₁(t_{b}+T_{V}) corresponds to the signal value x₂(t_{b}) according to FIG. 1. Otherwise, the method of operation of the embodiment according to FIG. 5 corresponds to the method of operation of the embodiment according to FIG. 1.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for determining a time difference between a first event and a second event, comprising the steps of:
determining a first position value from a first periodic signal that is triggered when the first event occurs;
determining a second position value from a second periodic signal that is triggered when the second event occurs; and
determining the time difference from a difference between the first and second position values.

2. The method of claim 1, wherein the time difference is determined by weighting the position difference with a proportionality factor.

3. The method of claim 1, wherein the first and second periodic signal are generated using signal generators being assigned to the first and the second periodic signal, respectively.

4. The method of claim 1, wherein the first and second periodic signals are sampled only after being triggered by the first and second events, with the sampled first and second periodic signals representing input values for signal evaluation means.

5. The method of claim 1, wherein the time difference is used to determine a position of a movable magnet in a magnetostrictive position measuring system.

6. A position measuring system, comprising a measurement signal evaluation means for determining a time difference between a first event and a second event, the measurement signal evaluation means configured to
determine a first position value from a first periodic signal that is triggered when the first event occurs,
determine a second position value from a second periodic signal that is triggered when the second event occurs, and
determine the time difference from a difference between the first and second position values.

7. A position measuring system, comprising:
a fist signal generator signal producing a first periodic signal;
a first A/D converter receiving the first periodic signal;
a second signal generator signal producing a second periodic signal;
a second A/D converter receiving the second periodic signal;
an OR gate receiving a first trigger signal produced by an occurrence of a first event, and a second trigger signal and second event respectively, and transmitting the first and second trigger signals to corresponding trigger inputs of the first and second A/D converters and producing first and second triggered output signals that correspond to the periodic signals at a time of the first and second event; and
an evaluation unit receiving at a first input the first triggered output signals corresponding to values of the first periodic signal for the first event and the second event, and receiving at a second input the second triggered output signals corresponding to values of the second periodic signal for the first event and the second event, the evaluation unit having an output that generates position values to be used for determining the time difference from a position difference between the first and second position values.
